(19) United States
(12) Patent Application Publication
(10) Pub. No.: US 2005/0065993 A1
(43) Pub. Date: Mar. 24, 2005

(54) Job network configuration file creating device and creating method

(76) Inventors: Masanori Honda, Sagamihara (JP); Yusuke Izumida, Chigasaki (JP); Atsushi Murase, Sagamihara (JP); Yukinori Sakashita, Yamato (JP); Masahide Sato, Kawasaki (JP)

Correspondence Address: MATTINGLY, STANGER & MALUR, P.C., SUITE 370, 1800 DIAGONAL ROAD, ALEXANDRIA, VA, 22314, US

(21) Appl. No.: 10/816,816

(22) Filed: Apr. 5, 2004

(30) Foreign Application Priority Data
Sep. 18, 2003 (JP) 2003-325393 (P)

(51) Int. Cl. G06F 15/16

(52) U.S. Cl. 709/200

(57) ABSTRACT

The device creates a job network configuration file that prescribes an execution procedure of a job in an information processing apparatus. This device comprises a template input unit, a definition file input unit, a setting data input unit and a creation processing unit. The template input unit can receive a template file including an undefined variable, the template file being prepared in connection with the job network configuration file. The definition file input unit can receive a definition file that establishes an association between the variable used in the template file and setting data that is input by an user in connection with a setting of the job network configuration file. The setting data input unit can receive input of the setting data from the user. The creation processing unit can create the job network configuration file in accordance with the definition file and the template file based on the setting data.

### BACKGROUND OF THE INVENTION

1. Field of the Invention

The present invention relates to a creation of a job network configuration file that prescribes an execution procedure of a job in an information processing apparatus.

2. Description of the Related Art

Jobs for information processing apparatuses include various different types of standard jobs. For example, a management job of a large-capacity storage apparatus requires, as one type of standard job, that a large amount of data be backed up periodically. A job network is one known technology that enables these various types of standard jobs to be performed automatically and reduces burden on human operators. A job network is a technology that prepares a ‘job network configuration file’ that prescribes the procedure for executing jobs and makes the information processing apparatus automatically execute these jobs. The job execution procedure is defined by, for example, the types of jobs to be executed, the times at which they are to be executed, the output destinations, and the relationships between the jobs.

In order to ensure execution of the intended standard jobs, the ‘job network configuration file’ should be prepared correctly and in detail. A technology to support the creation of the job network configuration file is described in JP2001-166928A, for example.

Creation of a job network configuration file requires an in-depth knowledge of the system configuration, including the details of the entire system incorporating the information processing apparatus that is to execute the jobs. For the job network configuration file, various settings should be accurately carried out in accordance with the system configuration.

However, the system administrator does not always possess such advanced knowledge. It is therefore desired to provide a technology for readily creating a job network configuration file regardless of whether the system administrator possesses the high-level knowledge. For example, in the conventional art, the task of creating a job network configuration file and of modifying it when the system configuration or the standard jobs are changed are the responsibility of a system engineer having advanced knowledge; it means that a job network configuration file is not always readily prepared. If a job network configuration file can be created easily by the system administrator, an appropriate job network configuration file can be prepared quickly and system convenience can be improved.

### SUMMARY OF THE INVENTION

An object of the present invention is to provide a technology for readily creating a job network configuration file even by someone who does not possess detailed knowledge regarding such a file.

In one aspect of the present invention, there is provided a device which creates a job network configuration file that prescribes an execution procedure of a job in an information processing apparatus. This device comprises a template input unit, a definition file input unit, a setting data input unit and a creation processing unit. The template input unit can receive a template file including an undefined variable, the template file being prepared in connection with the job network configuration file. The definition file input unit can receive a definition file that establishes an association between the variable used in the template file and setting data that is input by an user in connection with a setting of the job network configuration file. The setting data input unit can receive input of the setting data from the user. The creation processing unit can create the job network configuration file in accordance with the definition file and the template file based on the setting data.

In this job network configuration file creating device, the job network configuration file can be created in accordance with the definition file and the template file based on the setting data. Accordingly the job network configuration file can be easily created even by someone who does not possess detailed knowledge regarding such a file.

The present invention need not necessarily incorporate all of the characteristics described above, some of such characteristics may be omitted, and some may be combined in an appropriate fashion. The present invention may be realized in forms other than the job network configuration file creating device. For example, it may be constructed as a support method that supports the creation of a job network configuration file using a computer, a method for creating a job network configuration file, a computer program that implements such a support method or creation method on a computer, a recording medium on which such a computer program is recorded, or data signals in which such a computer program is realized in a carrier wave. Such a recording medium may consist of one of various types of computer-readable recording media, such as a flexible disk, a CD-ROM, a DVD, an opto-magnetic disk, an IC card, a ROM cartridge, a punch card, a printed matter on which symbols are printed, such a bar code, a storage device mounted inside a computer (memory such as a RAM or ROM), or an externally-mounted storage device.

These and other objects, features, aspects, and advantages of the present invention will become more apparent from the following detailed description of the preferred embodiments with the accompanying drawings.

### BRIEF DESCRIPTION OF THE DRAWINGS

FIG. 1 shows the basic construction of an information processing system embodying the present invention.

FIG. 2 shows an example of a template file.

FIG. 3 shows the content of a variable definition file.

FIG. 4 shows a flow chart of a job network creation process.

FIG. 5 shows an example of a setting data input screen.

FIG. 6 shows the content of a variable definition file in connection with a modification.

FIG. 7 shows an example of a setting data input screen in connection with a modification.

FIG. 8 shows a flow chart of the assist file creation process.

### DESCRIPTION OF THE PREFERRED EMBODIMENT

Next, aspects of the present invention will be described in the following order on the basis of embodiments:
A. Apparatus Construction
B. Template File
C. Variable Definition File
D. Job Network Creation Process
E. Modifications

A. Apparatus Construction

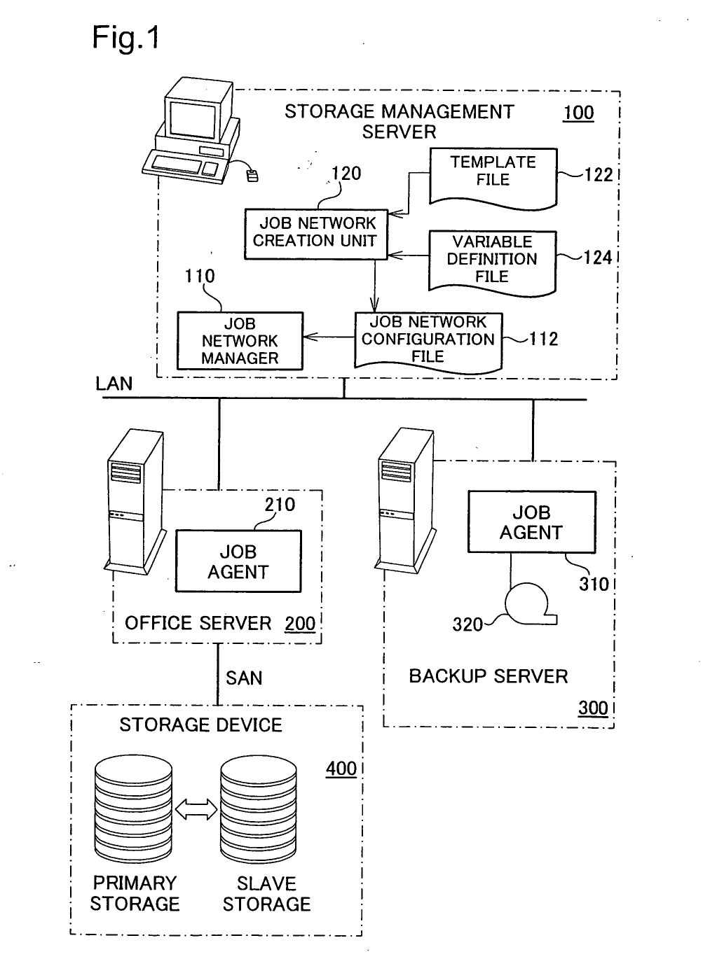

FIG. 1 shows the basic construction of an information processing system embodying the present invention. This system is composed of a storage management server 100, an office server 200 and a backup server 300 mutually interconnected over a local area network LAN. The office server 200 executes various tasks such as invoice processing and customer information management, and application programs (not shown in the drawing) used in the implementation of these tasks are installed thereon. The office server 200 is connected to a storage device 400 via a SAN network, and executes tasks while accessing various databases stored on the storage device 400. The storage device 400 comprises a primary storage and a slave storage, which is a backup of the primary storage. The contents of the primary storage are mirrored in the slave storage from time to time.

The backup server 300 has a tape drive 320, and backs up the data in the storage device 400 regularly onto a magnetic tape.

The storage management server 100 manages the operation of the office server 200 and the backup server 300. The management tasks include standard jobs such as instruction of the backup server 300 to perform backup of the storage device 400, for example. In the drawing, a construction that enables these standard jobs to be performed automatically is shown as function blocks.

In this embodiment, the various function blocks shown in the drawing are implemented via software through the installation of programs on the storage management server 100, office server 200 or backup server 300. One or more of these function blocks may be implemented via hardware, however.

The configuration for execution standard jobs in a preset sequence is called a job network, and the file that prescribes the procedure for job execution is termed a job network configuration file. In this embodiment, a job network configuration file 112 is pre-loaded onto the storage management server 100. The contents of the job network configuration file 112 will be described below. A job network manager 110 in the storage management server 100 executes the jobs prescribed in the job network configuration file 112.

The job network may include jobs involving operations performed by the office server 200 or the backup server 300 based on instructions from the storage management server 100. In order to enable the execution of these jobs, the office server 200 and backup server 300 include job agents 210 and 310, respectively. These job agents 210 and 310 execute jobs in accordance with instructions from the storage management server 100. For example, in the job network that performs backup to a magnetic tape, the job agent 210 of the office server 200 splits the storage apparatus 400 into primary storage and slave storage, and instructs that data be transferred from the slave storage to the backup server 300. The job agent 310 of the backup server 300 receives the data from the slave storage and drives the tape drive 320 to perform backup to the magnetic tape. When magnetic tape backup is carried out, access to the storage apparatus 400 may be temporarily halted.

The storage management server 100 also includes a function to support the creation of the job network configuration file 112. This creation function uses a template file 122 and a variable definition file 124. A job network creation unit 120 has the function of creating the job network configuration file 112 with reference to the template file 122 and the variable definition file 124 and registering the job network configuration file 112 as a subject of execution by the job network manager 110. The template file 122 and variable definition file 124 are described below.

B. Template File

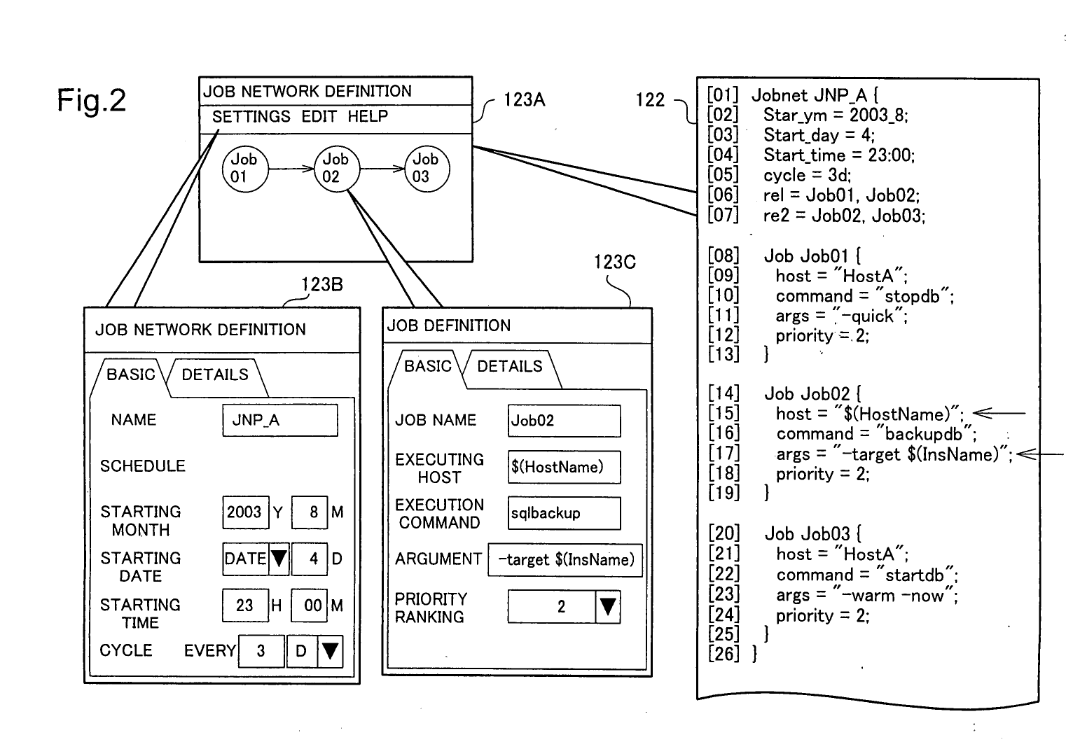

FIG. 2 shows an example of a template file 122. For ease of explanation, line numbers are provided at the left-hand side in the brackets. The template file 122 contains at least part of the job network configuration file 112 in the form of user-specifiable variables. In the example shown in the drawing, ‘HostName’ in the 15^{th} and ‘InsName’ in the 17^{th} line are variables. Because the template file 122 has the same format as the job network configuration file 112, the job network configuration file 112 is created by replacing these undefined variables with the actual data. A template file is prepared for each job network configuration file to be created or for each standard job.

In the example shown in FIG. 2, settings for linking the three jobs Job01-Job03 are shown in lines 1 through 7. The contents of jobs Job01-Job03 are indicated in lines 8-13, 14-19 and 20-26, respectively. In this example, the variable ‘HostName’ indicates the name of the host computer on which the job Job02 is to be executed, while the variable ‘InsName’ indicates the argument to be passed to the job Job02.

An example in which the contents of the template file 122 are displayed in GUI format is shown at the left side of the drawing. In the window 123A, the linked state of the jobs Job01-Job03 is shown. If the user clicks on the ‘Settings’ menu item, a window 123B that displays the overall settings for the job network, i.e., the settings in lines 1-7 of the job network configuration file 112, is displayed. If the user clicks on the icon for each job in the window 123A, a window 123C that indicates the settings for the selected job is displayed.

C. Variable Definition File

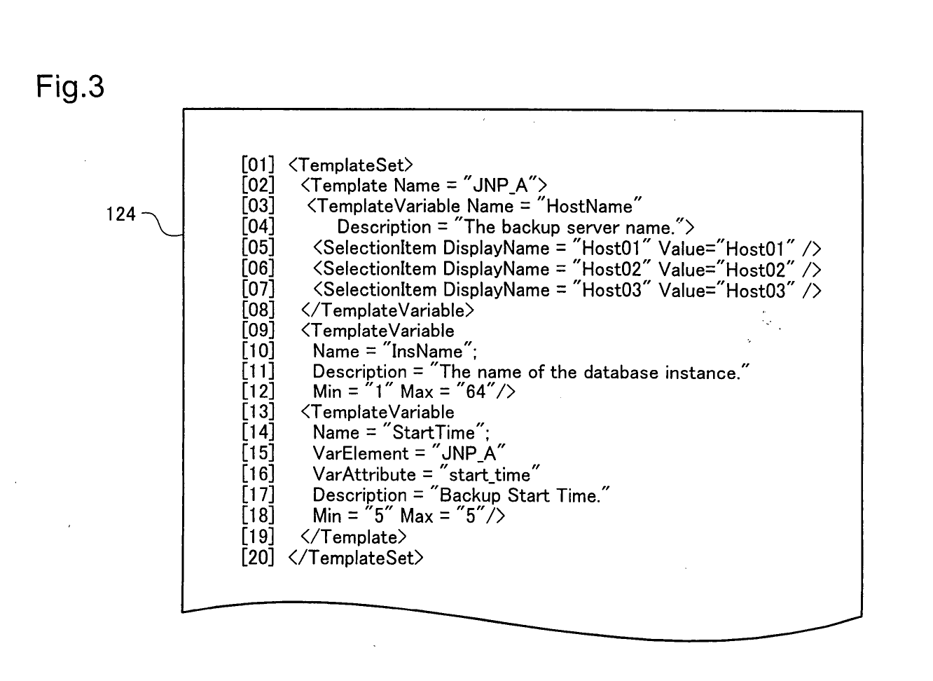

FIG. 3 shows the contents of the variable definition file 124. The variable definition file 124 can be created using various languages, but in this embodiment, XML, which offers superior versatility and expandability, is used. Therefore, the content of each variable is defined using a tag. As is widely known, in XML, various tags can be defined using a file called a DTD (Document Type Definition). The tags used in this embodiment are classified into SelectionItem elements, AutoFill elements, Condition elements and so on.

SelectionItem elements are elements that can be selected from among pre-established selection options, and correspond to the tags displayed in lines 5-7 in the drawing. In this example, ‘Host01’, ‘Host02’ and ‘Host03’ are displayed as the selection options for the variable ‘HostName’ in the third line. Selection item numbers 1-3 are allocated to these selection options in the order in which they are written in the variable definition file 124. In this example, if the user enters the number ‘1’ as user setting data, Host01 is set as the variable. In this way, the user can carry out proper setting even where the specific data that can be entered into ‘HostName’ and the input format are not known.

AutoFill elements are elements for which a variable is automatically fixed through the use of preset conditions. These conditions are prescribed using Condition elements. By combining these conditions, the variable ‘InsName’, for example, can be automatically defined in accordance with the content of the setting for a different variable such as ‘HostName’. Therefore, the number of operations that must be performed by the user can be reduced, and conflicts among the settings of multiple different variables can be avoided.

The variable definition file 124 includes ‘Description’ items, i.e., text explanations of a variable, as shown in lines 4, 11 and 17 in FIG. 3. Providing these text explanations to the user enables the user to more easily understand the meaning of each variable. For example, a method may be adopted in which the explanations described above are provided to the user and user setting data input is received in sequential order. This would enable even easier input by the user. It is moreover acceptable if the variable definition file 124 includes data that instructs such matters as the positions of the input areas, supplementary text strings, carriage returns and the like displayed in the wizard, in order to enable input using a graphical user interface. A construction may furthermore be adopted in which the variable definition file 124 includes information specifying such things as (i) limit values for a given variable, such as the maximum and minimum values, (ii) the sequence of variable input, (iii) the conditions governing the display of prompts for user input, or (iv) the conditions governing automatic variable setting.

D. Job Network Creation Process

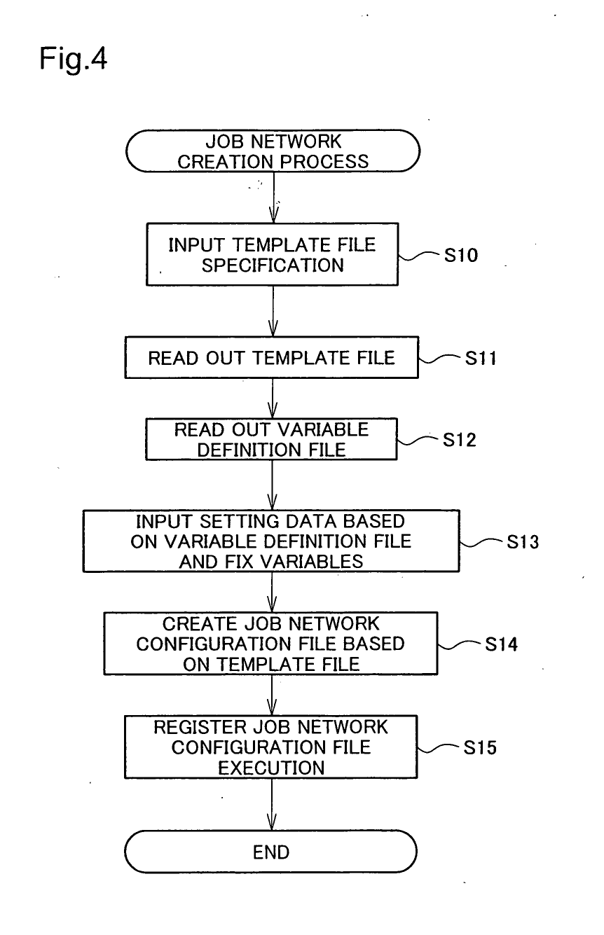

FIG. 4 shows a flow chart of the job network creation process, which is executed by the CPU of the storage management server 100 in accordance with user instructions. The process is executed whenever it is necessary to create a new job network configuration file or change an existing one, such as where the system configuration has been changed, or where the content of a standard job has changed. In this embodiment, the job network configuration file is changed by overwriting the old file with the newly created file, but it is acceptable if the old file is used and changes are simply made thereto.

When the process begins, the user selects a template file in accordance with the contents of the standard jobs for which the job network configuration file is to be created. The CPU of the storage management server 100 specifies this template file 122 based on the user's operation (step S10), and reads the template file 122 (step S11). The template file may be specified as one of the arguments for various commands, such as a command to begin the process.

Next, the CPU reads the variable definition file 124 corresponding to the selected template file 122 (step S12), and inputs the setting data based on the variable definition file 124 and fixes the values of the variables contained in the template file 122 (step S13). While this data may be entered in various formats, in this embodiment, it is entered in an interactive format, as described below.

The CPU creates a job network configuration file 112 by setting the fixed values for the various variables (step S14). The created job network configuration file 112 is then registered as a subject for execution (step S15).

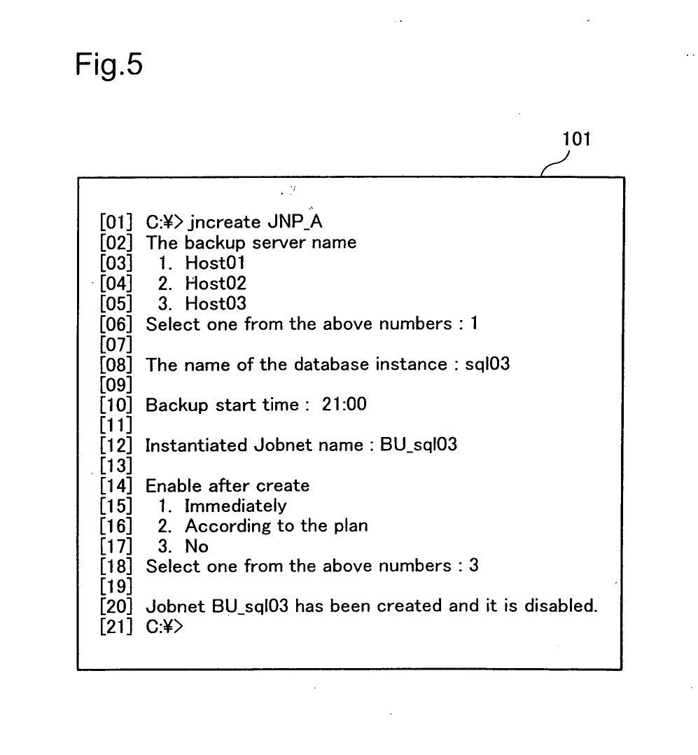

FIG. 5 shows an example of a setting data input screen comprising an example of the display of the screen 101 of the storage management server 100. When the user specifies a template entitled ‘JNP_A’ and inputs a command ‘jncreate’ to create a job network configuration file (first line), display prompting selection of a server name using the numbers 1 through 3 is displayed (lines 2-6). This display is based on lines 4-7 of the variable definition file shown in FIG. 3. In this example, a situation is shown in which the user inputs the setting data ‘1’, as shown in line 6. Setting data is then entered in lines 8, 10, 12 and 18 in the same fashion.

The use of a template file and variable definition file according to the embodiment described above enables an appropriate job network configuration file to be created even if the user lacks a detailed understanding thereof. The storage management server 100 can convert the data input by the user into a format suitable for the job network configuration file through the use of the variable definition file. Therefore, the use of the variable definition file enables the user to input setting data in a more understandable format. In this embodiment, the burden on the user of creating the job network configuration file is reduced via these operations.

E. Modifications

E1. Modification 1

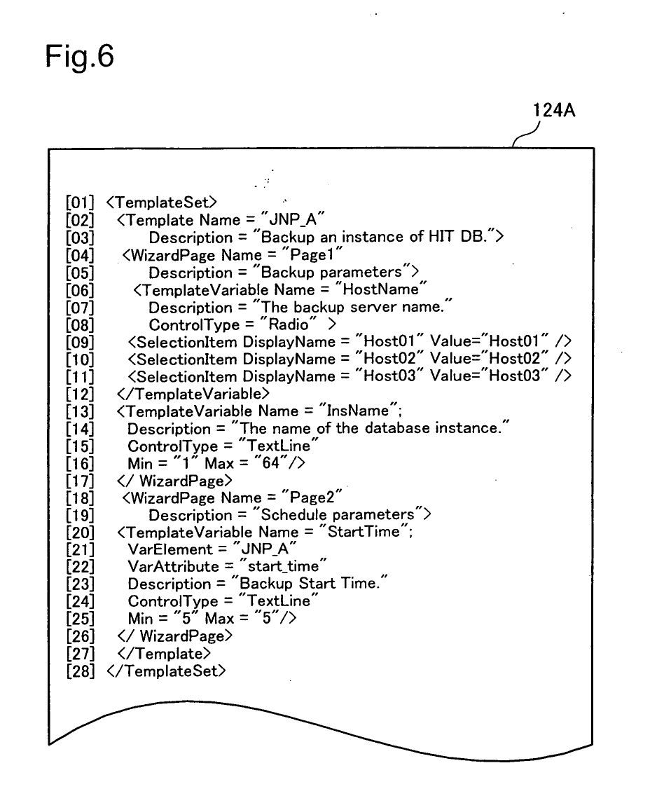

The setting data may be input through the use of a so-called ‘wizard’. FIG. 6 shows the content of a variable definition file 124A comprising a modification of the embodiment described above. The contents of the wizard display are controlled using the ‘Wizard Page’ tags shown in lines 4 and 5, for example.

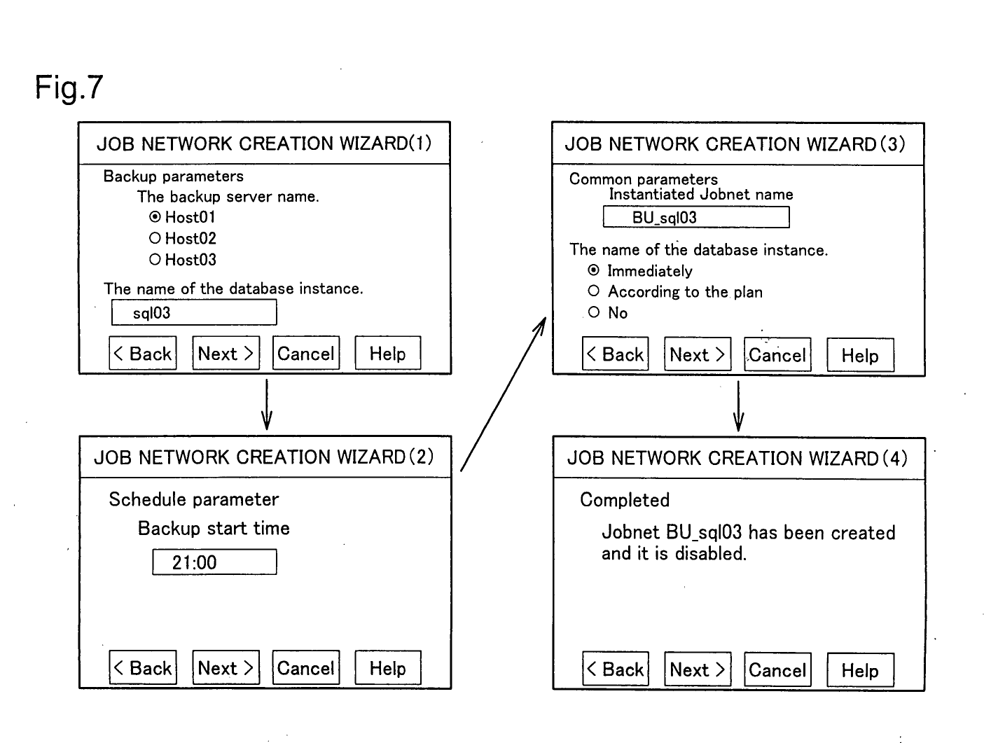

FIG. 7 shows an example of a setting data input screen included in a modification of the embodiment described above. Four examples of the screen that are displayed sequentially are shown along arrows on the drawing. In the Wizard (1) screen, the server name is selected by clicking on a radio button, and the name of the database to be backed up is entered as a text string. This display is equivalent to lines 4-17 of the variable definition file shown in FIG. 6.

Setting data can be subsequently entered using the Wizard (2) through Wizard (4) screens in the same manner described above. This format has the advantage of making it easier for the user to input the setting data.

E2. Modification 2

Setting data input need not be performed in an interactive fashion, and it is acceptable if such data is read in at one time from a file (hereinafter a ‘settings file’) in which setting data is recorded preliminarily. This data input method offers the advantage that the setting data can be entered more quickly than it can via interactive input. When this method is used, the storage management server 100 may create an assist file, i.e., a file equivalent to a settings file template, in order to reduce the burden on the user of creating the settings file. For example, where the variable definition file includes description data that describes the content of the setting data, the assist file can contain the description data and data that describes to the user the locations in which the setting data are to be entered.

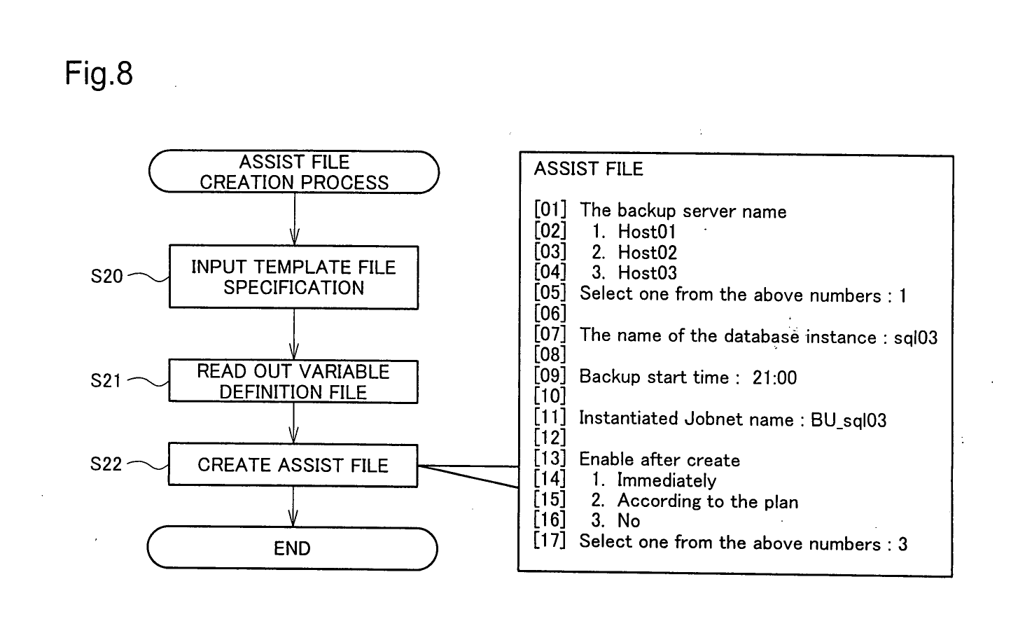

FIG. 8 shows a flow chart of the assist file creation process. This process is executed by the storage management server 100 when the user enters an assist file creation command, rather than the job network configuration file creation command.

When this process is begun, the storage management server 100 inputs the template file specification based on the user's operation (step S20) and reads the corresponding variable definition file (step S21). It then creates an assist file based on this variable definition file (step S22). An example of an assist file is shown at the right side of the drawing. It comprises the interactive screen display previously shown in FIG. 5 shown in a file format. The user can create a settings file by inputting the respective setting data in lines 5, 7, 9, 11 and 17. The assist file can be created in various formats other than the one shown, and it is acceptable if the assist file contains only the parts to be input by the user (lines 5, 7, 9, 11 and 17).

The job network configuration file creation process where a settings file is used is identical to the process explained in connection with FIG. 4. However, in step S13, the setting data is read in at one time from a settings file specified by the user, rather than through interactive operation.

Although the present invention has been described and illustrated in detail, it is clearly understood that the same is by way of illustration and example only and is not to be taken by way of limitation, the spirit and scope of the present invention being limited only by the terms of the appended claims.

1. A device for creating a job network configuration file that prescribes an execution procedure of a job in an information processing apparatus, the device comprising:
a template input unit configured to receive a template file including an undefined variable, the template file being prepared in connection with the job network configuration file;
a definition file input unit configured to receive a definition file that establishes an association between the variable used in the template file and setting data that is input by an user in connection with a setting of the job network configuration file;
a setting data input unit configured to receive input of the setting data from the user; and
a creation processing unit configured to create the job network configuration file in accordance with the definition file and the template file based on the setting data.

2. A device according to claim 1, wherein the definition file includes description data that describes contents of the setting data,
and wherein the setting data input unit receives the input interactively using the description data.

3. A device according to claim 1, wherein the definition file includes information specifying one or more of a limit value for the variable, order of input of the variable, a condition governing display of a prompt for user input, and a condition governing automatic setting of the variable,
and wherein the setting data input unit performs the input based on the specifying information.

4. A device according to claim 1, wherein the setting data input unit receives from the user specification of a setting file that includes the setting data and inputs the setting data from the setting file.

5. A device according to claim 4, wherein the definition file includes description data that describes contents of the setting data,
and wherein the device further comprises an assist file creating unit configured to create as a template for the setting file an assist file that includes the description data and data that indicates the user locations at which the setting data is to be entered.

6. A method of supporting creation of a job network configuration file with the aid of a computer, the job network configuration file prescribing an execution procedure of a job in an information processing apparatus, the method comprising the steps of:
(a) receiving a template file including an undefined variable, the template file being prepared in connection with the job network configuration file;
(b) receiving a definition file that establishes an association between the variable used in the template file and setting data that is input by an user in connection with a setting of the job network configuration file;
(c) receiving input of the setting data from the user; and
(d) creating the job network configuration file in accordance with the definition file and the template file based on the setting data.

7. A method according to claim 6, wherein the definition file includes description data that describes contents of the setting data,
and wherein the step (c) is the step of receiving the input interactively using the description data.

8. A method according to claim 6, wherein the definition file includes information specifying one or more of a limit value for the variable, order of input of the variable, a condition governing display of a prompt for user input, and a condition governing automatic setting of the variable,
and wherein the step (c) is the step of performing the input based on the specifying information.

9. A method according to claim 6, wherein the step (c) is the step of receiving from the user specification of a setting file that includes the setting data and inputting the setting data from the setting file.

10. A method according to claim 9, wherein the definition file includes description data that describes contents of the setting data,
and wherein the method further comprises the step of creating as a template for the setting file an assist file that includes the description data and data that indicates the user locations at which the setting data is to be entered.

11. A computer program, stored on a computer readable medium, for creating a job network configuration file that prescribes an execution procedure of a job in an information processing apparatus, the computer program comprising:
a first code that receives a template file including an undefined variable, the template file being prepared in connection with the job network configuration file;
a second code that receives definition file that establishes an association between the variable used in the template file and setting data that is input by an user in connection with a setting of the job network configuration file;
a third code that receives input of the setting data from the user; and
a fourth code that creates the job network configuration file in accordance with the definition file and the template file based on the setting data.

12. A computer program according to claim 11, wherein the definition file includes description data that describes contents of the setting data,
and wherein the third code receives the input interactively using the description data.

13. A computer program according to claim 11, wherein the definition file includes information specifying one or more of a limit value for the variable, order of input of the variable, a condition governing display of a prompt for user input, and a condition governing automatic setting of the variable,
and wherein the third code performs the input based on the specifying information.

14. A computer program according to claim 11, wherein the third code receives from the user specification of a setting file that includes the setting data and inputs the setting data from the setting file.

15. A computer program according to claim 14, wherein the definition file includes description data that describes contents of the setting data,
and wherein the computer program further comprises a fifth code that creates as a template for the setting file an assist file that includes the description data and data that indicates the user locations at which the setting data is to be entered.

16. A device for creating a job network configuration file that prescribes an execution procedure of a job in an information processing apparatus, the device comprising:
a template file storage unit configured to store a template file including an undefined variable, the template file being prepared in connection with the job network configuration file;
a variable definition file storage unit configured to store a variable definition file that establishes an association between the variable used in the template file and setting data that is input by an user in connection with a setting of the job network configuration file; and
a job network creation unit configured to receive input of the setting data from the user and create the job network configuration file by fixing a value of the variable contained in the template file based on the setting data and setting the fixed value of the variable in the template file.

17. A device according to claim 16, wherein the variable definition file includes description data that describes contents of the setting data,
and wherein the job network creation unit receives the input interactively using the description data.

18. A device according to claim 16, wherein the variable definition file includes information specifying one or more of a limit value for the variable, order of input of the variable, a condition governing display of a prompt for user input, and a condition governing automatic setting of the variable,
and wherein the job network creation unit performs the input based on the specifying information.

19. A device according to claim 16, wherein the job network creation unit receives from the user specification of a setting file that includes the setting data and inputs the setting data from the setting file.

20. A device according to claim 19, wherein the variable definition file includes description data that describes contents of the setting data,
and wherein the job network creation unit creates as a template for the setting file an assist file that includes the description data and data that indicates the user locations at which the setting data is to be entered.
